(19) United States
(12) Patent Application Publication
(10) Pub. No.: US 2007/0103757 A1
(43) Pub. Date: May 10, 2007

(54) THREE-DIMENSIONAL COLOR IMAGE RECORDING APPARATUS

(75) Inventors: Takashi KUBARA, Fukuoka (JP); Kunihiro SATO, Hyogo (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/550,945

(22) Filed: Oct. 19, 2006

(30) Foreign Application Priority Data
Oct. 20, 2005 (JP) 2005-305501

(51) Int. Cl. G02B 26/08

(52) U.S. Cl. 359/223

(57) ABSTRACT

The invention displays a lattice fringe on a spatial light modulator such as a liquid crystal panel or a digital mirror device panel, irradiates it with laser beams in three primary colors red, green and blue, and uses a primary diffracted beam created by the lattice fringe as an image recording reference beam. On moving the lattice fringe on the spatial light modulator on the modulator, a phase of the diffracted beam shifts due to a movement of a fringe, a phase shift amount of the beam is proportionate to an amount of movement of the fringe, and becomes unconnected to a wavelength of the beam. By this method, as an optical phase can be accurately shifted rendering unnecessary a device for detecting or regulating the optical phase, a system configuration of an image recording apparatus becomes simple.

### BACKGROUND OF THE INVENTION

The present invention relates to a color phase shift digital holography which makes possible a three-dimensional display used in an image technology field, an amusement field, an entertainment field, an internet field, an information field, a multimedia field, a communications field, an advertising and publicity field, a medical field, an art field, an education field, a design support field, a simulation field, a virtual reality and the like, as well as an apparatus which records a three-dimensional color image by the phase shift digital holography. In particular, it relates to an apparatus which, having an advantage of being capable of a simultaneous high-speed recording of a color image as a red, green and blue three primary color hologram, records a high-quality three-dimensional color image with a simple system configuration.

To date, in a case of recording a three-dimensional image by a digital holography, when using a light receiving element with a pixel pitch larger than a light wavelength, a quality of a recorded image has decreased on receiving an effect of an interference fringe made by a plurality of object beams. A phase shift holography has been invented as a technology for removing the interference fringe made by the plurality of object beams and recording a high-quality three-dimensional image. In a phase shift digital holography, as a hologram is recorded by changing a phase of a reference beam, it is necessary to accurately shift an optical phase.

As a method of shifting the optical phase, a method inserting a thin glass plate in a light propagation channel and a method changing a position of a mirror with a piezoelectric element are employed. With the method inserting the glass plate, although a system configuration of a recording apparatus is simple, as it is difficult to insert and remove the glass plate at a high speed, the method is not suitable for a high-speed recording. With the method using the piezoelectric element, as a control device which detects the optical phase and regulates the position of the mirror is necessary, the apparatus which carries out the optical phase shift is extensive and expensive. Also, with heretofore known methods, as a phase shift amount has a dependency on a light wavelength, it being necessary to shift a phase when recording each of RGB holograms, it is not possible to simultaneously record color images as the RGB holograms (for example, refer to Patent Document 1).

In order to solve these problems, a parallel quasi-phase shift digital holography capable of instantaneous measurement has been devised (for example, refer to Nonpatent Document 1). This technique, for example, causes a reference beam to permeate a phase shift array device having a 0, 2π/3, −2π/3 three stage distribution for spatially changing a phase of the reference beam, changes it into three stages, records information on three interference fringes of differing reference beam phases in one hologram, carries out a calculator process on the recorded hologram, and obtains information on an object beam wavefront necessary for an image reproduction.

However, the method aligns the spatial phase distribution of the reference beam which permeates the phase shift array device with a disposition of pixels of a CCD on a CCD surface, makes one interval of the phase distribution the same as a size of the CCD pixel and, after carrying out a phase shift calculation with regard to a pixel of the reference beam in the recorded hologram of which the phase is 0, using four pixels, of which the phase is 2π/3, −2π/3, 2π/3, −2π/3, of pixels in a vicinity thereof, in order to obtain a complex amplitude distribution of an original pixel size on the CCD surface for a missing pixel by means of a linear interpolation, it being necessary to exactly align each pixel position of the phase shift array device with the CCD pixel disposition, an accuracy of the apparatus is required. Also, there is a problem of an error correction etc. in the event that a pixel position is out of alignment due to a disturbance. Also, primarily, there is a problem of whether or not it is possible to obtain a development of this kind of phase shift array device at a high accuracy and a low cost.

Patent Document 1: Japanese Patent No.3,471,556

Non-patent Document 1: Y. Awatsuji and M. Sasada, Appl. Phys. Lett. 85 (2004) 1069.

In this way, with the heretofore known phase shift holography, there being a problem with the method of shifting the phase of the reference beam accurately and quickly when incorporating the interference fringe generated by the phase shifted reference beam and object beam, and it also being difficult, with the parallel quasi-phase shift digital holography devised to solve the problem, to realize a high-accuracy phase shift array device which is a main component, there is also a problem of exactly aligning each pixel position of the phase shift array device with the CCD pixel disposition.

### SUMMARY OF THE INVENTION

The invention, relating to an apparatus which records a three-dimensional color image by means of a holography, enables a provision of an apparatus with a simple system configuration which can shift a phase of a reference beam accurately and quickly, and can also simultaneously record a color phase shift hologram.

As an improvement, the invention displays a lattice fringe on a spatial light modulator such as a liquid crystal panel or a digital mirror device panel, irradiates it with laser beams in three primary colors red, green and blue, and uses a primary diffracted beam created by the lattice fringe as an image recording reference beam. On moving the same lattice fringe on the modulator, a phase of the diffracted beam shifts due to a movement of a fringe, a phase shift amount of the beam is proportionate to only an amount of movement of the fringe, and becomes unconnected to a wavelength of the beam. For example, in a case in which a light and dark of the lattice fringe displayed on the modulator is inverted and the fringe moved by a half of a lattice interstice, the phase of the primary diffracted beam shifts by precisely π. By this method, as an optical phase can be accurately shifted rendering unnecessary a device for detecting or regulating the optical phase, a system configuration of an image recording apparatus becomes simple. Also, as the phase shift amount does not depend on the beam wavelength, a simultaneous recording of a color phase shift hologram in a three-dimensional image is possible.

As the apparatus in the invention, being able to carry out a switching of the displayed lattice fringe at a high speed by means of an electronic operation, can simultaneously record RGB images, it is possible to record a high-quality three-dimensional color image at a high speed. Furthermore, as the system configuration can be made simple, it is possible to develop a compact and low-priced three-dimensional color image recording apparatus.

The apparatus in the invention, as well as an object of recording the high-quality three-dimensional color image for a display, is also advantageous for an aim of a high-precision measurement of a shape, orientation and position of a three-dimensional colored object. Also, a real time recording of a three-dimensional color moving image being possible when using a pulse laser source of RGB three primary colors, a use can also be hoped for as a color moving image recording apparatus for a holographic television.

### BRIEF DESCRIPTION OF THE DRAWINGS

FIG. 1 is an illustration showing an embodiment of a three-dimensional color image recording apparatus using a phase shift digital holography of the invention;

FIG. 2 is an illustration of an m^{th} diffracted beam created by a parallel incident beam and a reflective lattice fringe;

FIG. 3 is an illustration of the m^{th} diffracted beam when the parallel incident beam and the lattice fringe are moved;

FIG. 4 is an illustration of a primary diffracted white beam created by a red, green and blue incident beam and the reflective lattice fringe of the invention;

FIG. 5 shows a recorded hologram before a phase shift and an enlarged image thereof;

FIG. 6 shows a phase shift hologram of the invention and an enlarged image thereof;

FIG. 7 shows three-dimensional color images reproduced from the phase shift hologram of the invention; and

FIG. 8 shows three-dimensional color images according to a time-division reproduction of a red, green and blue image of the invention.

### DETAILED DESCRIPTION OF PREFERRED EMBODIMENTS

The invention displays a lattice fringe on a spatial light modulator such as a liquid crystal panel or a digital mirror device panel, irradiates it with laser beams in three primary colors red, green and blue, and uses a primary diffracted beam created by the lattice fringe as an image recording reference beam. On moving the same lattice fringe on the modulator, a phase of the diffracted beam shifts due to a movement of a fringe, a phase shift amount of the beam is proportionate to only an amount of movement of the fringe, and becomes unconnected to a wavelength of the beam. For example, in a case in which a light and dark of the lattice fringe displayed on the modulator is inverted and the fringe moved by a half of a lattice interstice, the phase of the primary diffracted beam shifts by precisely π. By this method, as an optical phase can be accurately shifted rendering unnecessary a device for detecting or regulating the optical phase, a system configuration of an image recording apparatus becomes simple. Also, as the phase shift amount does not depend on the beam wavelength, a simultaneous recording of a color phase shift hologram in a three-dimensional image is possible.

### Embodiment

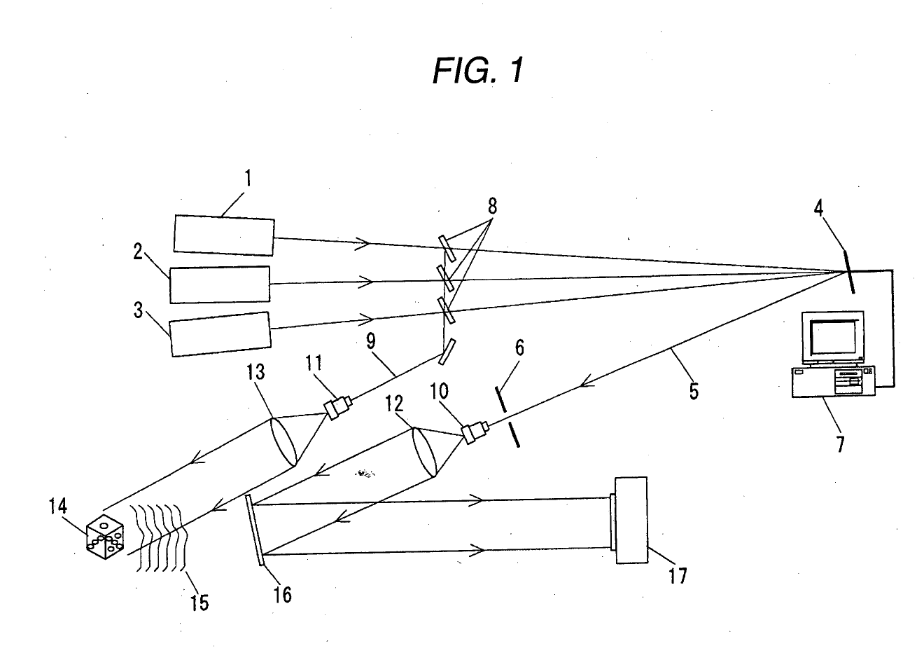

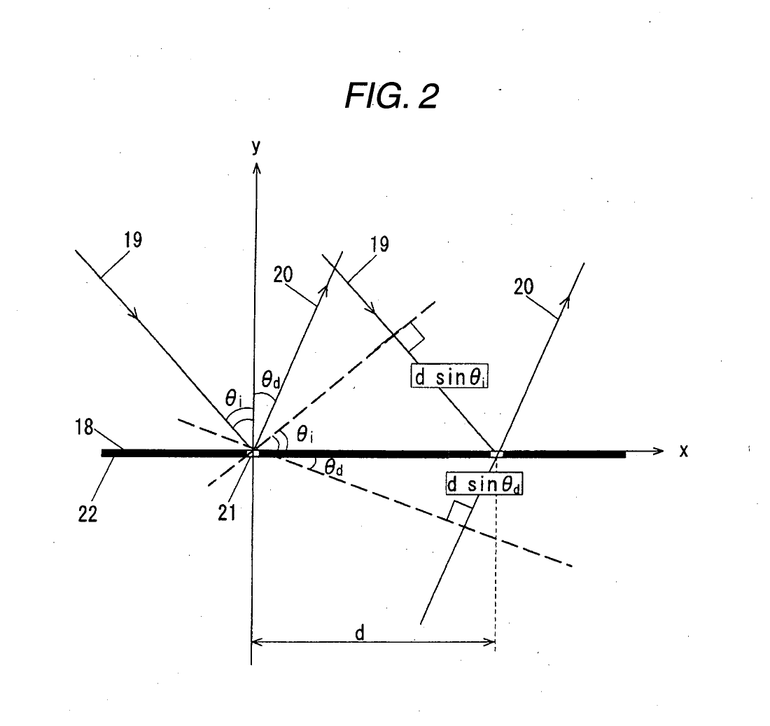

Hereafter, a description will be given, while referring to FIG. 1 and FIG. 2, of a three-dimensional color image recording apparatus using a phase shift digital holography of the invention.

FIG. 1 is an illustration showing the three-dimensional color image recording apparatus using the phase shift digital holography according to an embodiment of the invention, while FIG. 2 is an illustration of an m^{th} diffracted beam created by a parallel incident beam and a reflective lattice fringe. As a light source for a recording, each laser oscillator of a red laser oscillator 1, a green laser oscillator 2 and a blue laser oscillator 3 is used. A red semiconductor laser with a light wavelength of 650 nm has been used as the red laser oscillator 1, a semiconductor excited green solid-state laser with a light wavelength of 532 nm as the green laser oscillator 2, and a blue semiconductor laser with a light wavelength of 440 nm as the blue laser oscillator 3.

Laser beams from each of the red laser oscillator 1, the green laser oscillator 2 and the blue laser oscillator 3 are incident on a reflective liquid crystal panel 4, changing an angle of incidence so as the primary diffracted beams are superimposed on a straight line, and a white primary diffracted beam composed of superimposed red, green and blue beams is used as a reference beam 5 for the recording. A Victor Co. of Japan, Ltd. D-ILA (Direct Drive Image Light Amplifier) or a Hitachi LSM18HDA01B1 (1920×1080 pixels) can be used as the reflective liquid crystal panel 4. As it can be given a higher resolution than a transmissive type, a reflective liquid crystal has an advantage of a high light use efficiency. Red, green and blue reflected beams emanating from the reflective liquid crystal panel 4 and a high-order diffracted beam are intercepted using a diaphragm 6. Hologram data to be displayed on the reflective liquid crystal panel 4 are transmitted from a personal computer 7, moving the lattice fringe displayed on the reflective liquid crystal panel 4, and shifting a phase of the red, blue and green laser beams. Meanwhile, the red, blue and green laser beams are superimposed and synthesized into a white laser beam using beam splitters 8, and the synthesized white beam is used as an illumination beam 9 for an object irradiation. Two white beams are converted into parallel beams of a large diameter using objective lenses 10 and 11 and collimator lenses 12 and 13. By irradiating a subject 14 to be recorded with the illumination beam 9, an object beam 15 including configuration information of the subject 14 is generated. An optical system is set in such a way that a difference in an optical path length of the reference beam 5 and the object beam 15 to each laser source and a recording device falls within a coherence length of the laser, the reference beam 5 is reflected by a beam splitter 16, and red, green and blue interference fringes made by the reference beam 5 and the object beam 15 are each recorded by a color CCD 17.

In a phase shift holography, as a hologram is recorded by changing a phase of the reference beam 5, it is necessary to accurately shift an optical phase. Herein, a description will be given of a principle of an optical phase shift using the spatial light modulator 4. When using the spatial light modulator 4 to display the lattice fringe, it is possible to switch to an interstice and display position of the displayed lattice fringe accurately and quickly. When using the lattice fringe to diffract a beam, it being possible to regulate a diffraction angle of the diffracted beam by changing the interstice of the lattice fringe, it is possible to shift the phase of the diffracted beam by moving the display position of the fringe.

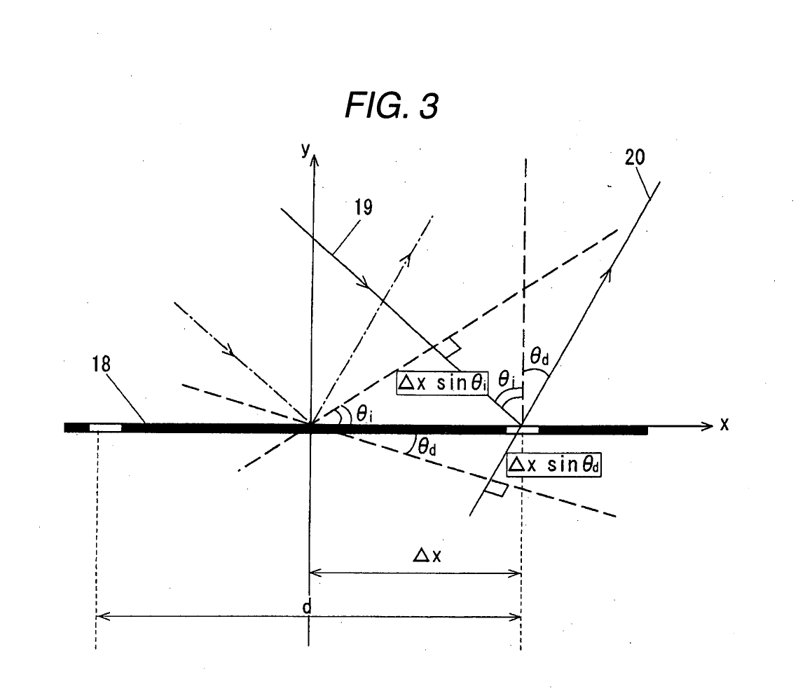

Parallel incident beams 19 incident on a reflective lattice fringe 18 and m^{th} diffracted beams 20 are shown in the illustrations in FIG. 2 and FIG. 3 of the m^{th} diffracted beams when the parallel incident beams and the lattice fringe are moved. The parallel incident beams 19 are specularly reflected by a white portion 21 on an x axis, and absorbed without being reflected by a black portion 22 on the x axis. The specularly reflected beams mutually interfere, as a result of which a diffraction of the beams occurs. When, with a light wavelength of the parallel incident beams 19 as λ and an interstice of the lattice fringe as d, a plane wave of an incidence angle θᵢ and an m^{th} diffracted plane wave of a diffraction angle θ_{d} are considered, a difference in optical path length between a beam reflected at an origin and a beam reflected at one point to a right is −d sin θᵢ+d sin θ_{d}. Consequently, between the incidence angle θᵢ and the diffraction angle θ_{d} of the m^{th} diffracted beam 20, and the wavelength λ, a relational equation
−d sin θᵢ+d sin θ_{d=}mλ Equation 1

is established. A phase of the specularly reflected beams differs by n from a phase of the incident beams 19 at a reflection point. Consequently, in the event that a mirror surface is at an origin of coordinates, as in FIG. 2, a phase of the m^{th} diffracted beams 20 differs by n from the phase of the incident beams at the origin.

As shown in FIG. 3, when the same lattice fringe is moved an infinitesimal distance Δx in an x axis direction, the phase of the reflected beam differs by n from the phase of the parallel incident beam 19 at a point x=Δx on the x axis. Incidentally, the phase of the parallel incident beam 19 at the point x=Δx is 2πΔx sin θ_{d}/λ behind a phase at the coordinate origin, while the phase of the reflected beam at the point x=Δx is 2πΔx sin θ_{d}/λ ahead of the phase at the coordinate origin. Consequently, as a phase difference between the parallel incident beam 19 and the m^{th} diffracted beam 20 at the coordinate origin shifts in accordance with the movement of the reflective lattice fringe 18, a shift amount of the phase difference is
Δφ=2π/λ(−Δx sin θᵢ+Δx sin θ_{d}) Equation 2

When a relationship of Equation 1 is substituted for Equation 2, a phase shift amount of
Δφ=2π·Δx/d·m Equation 3

is obtained. That is, when the lattice fringe is moved the infinitesimal distance Δx, a phase difference Δφ between the incident beam and the diffracted beam shifts by 2πmΔx/d.

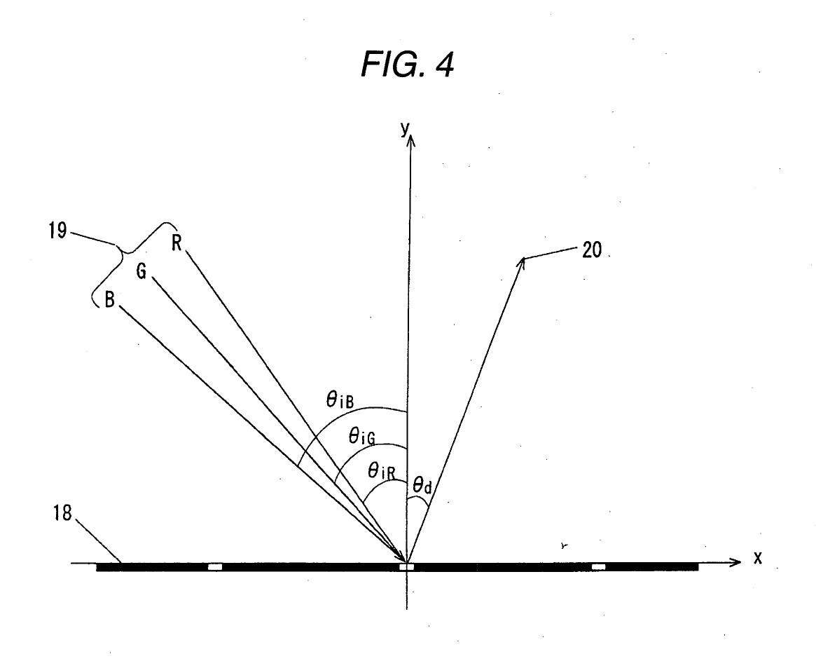

A point to be noted in Equation 3 is that the phase shift amount Δφ]has no dependence on the wavelength λ. Consequently, it is possible, by means of the movement of the reflective lattice fringe 18, to simultaneously shift a phase of beams having a variety of wavelengths by an identical value. As shown in FIG. 4, an illustration showing the red, green and blue incident beams of the invention and the primary diffracted white beam created by the reflective lattice fringe, in order that a diffraction angle θ_{d} of the primary diffracted beam becomes identical, the phase of the red, green and blue m^{th} diffracted beams 20 is simultaneously shifted by an identical value for RGB three primary color beams respectively.

In order to move the lattice fringe and accurately carry out a phase shift, it is possible to use a high resolution liquid crystal panel display panel with a high pixel pitch accuracy as the spatial light modulator 4. When using the reflective liquid crystal panel 4, as it is possible to electronically switch the position and interstice of the reflective lattice fringe 18, it is possible to shift the phase of the red, green and blue diffracted beams accurately and quickly. For example, when causing a parallel movement of a lattice fringe of an interstice d=2α, displayed on a reflective spatial light modulator of a pixel pitch α, by one pixel pitch Δx=α, a primary diffracted beam phase shift amount is φ=Π for the red, green and blue three primary color beams. When a lattice interstice d=4α is given a movement distance of Δx=α, 2α, 3α, a phase shift amount of the primary diffracted beam is φ=Π/2, Π, 3Π/2.

In the event that a light beam diameter is small, a widening of the diffraction angle occurs, as a result of which a beam diameter of the diffracted beam widens. However, as a widening Δθ_{d} of the diffraction angle is in the order of (wavelength/incident beam diameter), as long as the beam diameter is made sufficiently larger than the wavelength, it is possible to easily keep the widening of the diffraction beam small.

By a phase shift method using the spatial light modulator, it being possible by means of the movement of the displayed lattice fringe to shift the light phase with a high accuracy, the device for detecting or regulating the optical phase is unnecessary. Consequently, when using the phase shift method, the system configuration of the image recording apparatus using the phase shift holography becomes simple. Also as, by this method, the phase shift amount does not depend on the beam wavelength, it is possible to simultaneously shift the phase of the red, green and blue three primary color reference beams, so that recording the red, green and blue three primary color beams separately enables a simultaneous recording of red, green and blue holograms in a color image.

Given that a design is such that a superimposition of a transmission curve of a red, green and blue filter is removed and the red, green and blue laser beams can be completely separated, it is possible to simultaneously record RGB holograms using the color CCD. However, as a commercially available color CCD is designed in such a way that an optical transmittance characteristic curve for a wavelength of the red, green and blue filter is superimposed, it is difficult to simultaneously record clear RGB holograms using the commercially available CCD. In the event that it is not possible to completely separate the red, green and blue beams, it is necessary to record each color of hologram separately.

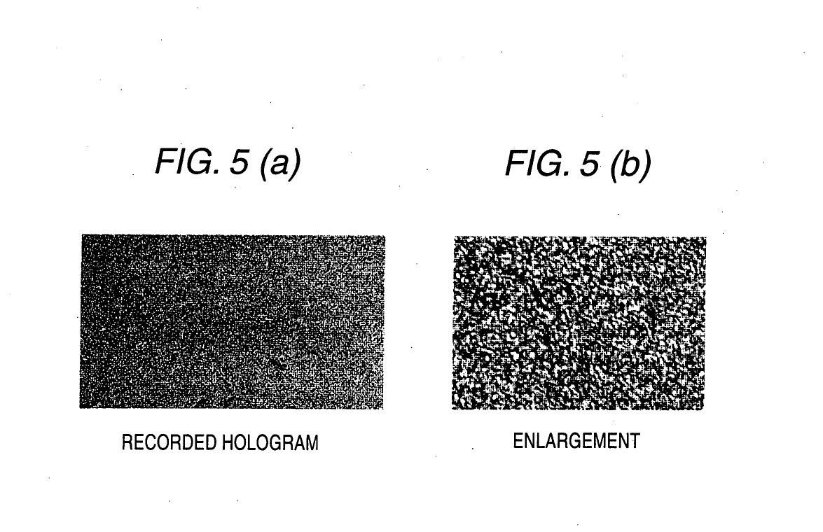

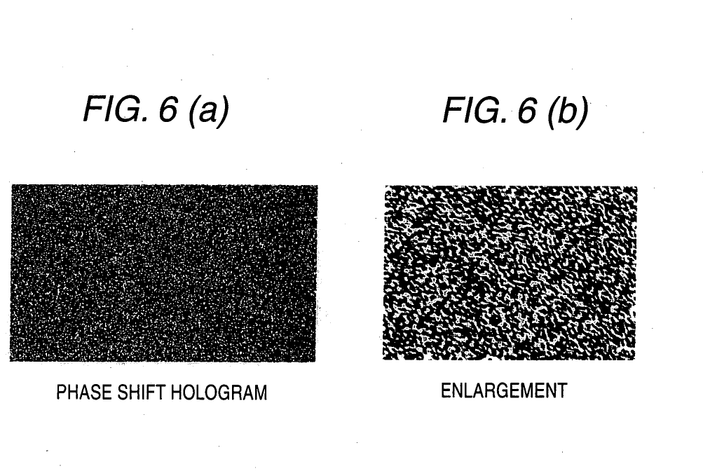

FIG. 5 shows a green hologram recorded by the CCD, while FIG. 6 shows a phase shift hologram obtained from the recorded hologram. The interference fringes are shown normalized in a 256 gradation. Hologram (a) has 1920×1080 pixels, while hologram (b), which is an enlargement thereof, has 300×200 pixels. When recording the hologram, as well as an interference fringe component made by the object beam and the reference beam, an interference fringe component made by a plurality of object beams is recorded. Only the former interference fringe component being necessary for an object beam wavefront reconstruction, the latter interference fringe component is not necessary for the object beam wavefront reconstruction. Also, as is clear from FIG. 5, a light intensity of the interference fringe component is low compared with an overall light intensity. When using two holograms recorded after changing the phase of the reference beam, it being possible, by means of the phase shift holography, to extract only a component necessary for an image reproduction, only that component normalized to the 256 gradation is shown in FIG. 6. Compared to the recorded hologram in FIG. 5, a clear interference fringe with a large contrast is obtained from the phase shift hologram in FIG. 6. By means of the phase shift holography, it is also possible to obtain a clear hologram for red and blue in the same way as for green.

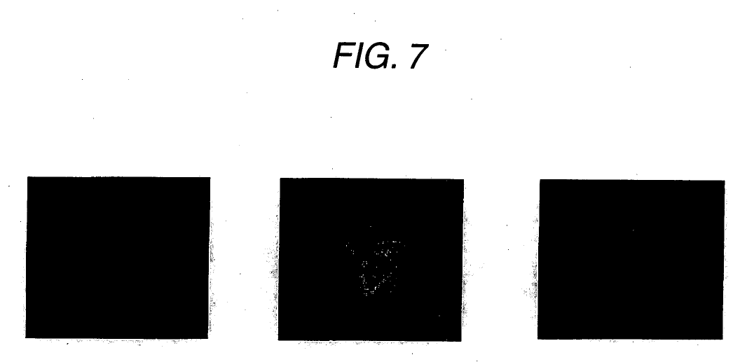

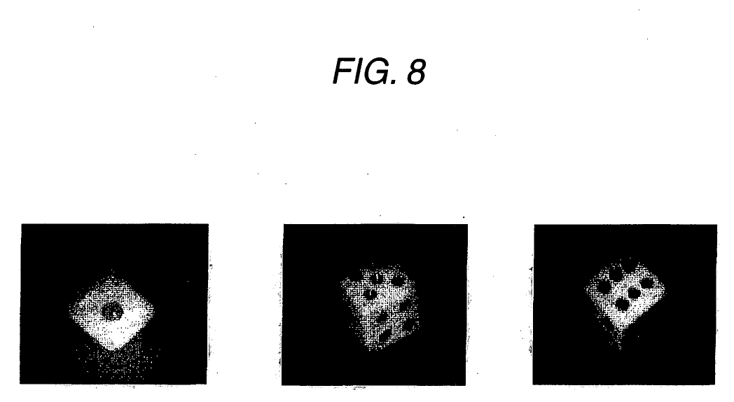

Photographs of a three-dimensional image reproduced using the phase shift hologram are shown in FIG. 7 and FIG. 8. FIG. 7 shows three-dimensional images of the red, green and blue three primary colors reproduced from respective color phase shift holograms. A die of which a length of one side is 2 cm has been recorded in a position 75 cm from the CCD. High-quality red, green and blue three-dimensional images having a high contrast and resolution are reproduced in the same position as the recorded object. FIG. 8 shows color three-dimensional images obtained by time-division reproducing the red, green and blue images. As the three-dimensional images of the three primary colors are time-division reproduced in exactly the same position at the same size, a high-quality three-dimensional color image is reproduced with no color drift.

The three-dimensional color image recording apparatus according to the invention can be used as a three-dimensional color image recording apparatus used in an image technology field, an amusement field, an entertainment field, an internet field, an information field, a multimedia field, a communications field, an advertising and publicity field, a medical field, an art field, an education field, a design support field, a simulation field, a virtual reality field, and the like.

What is claimed is:

1. A three-dimensional color image recording apparatus for a phase shifting digital holography, comprising:
a laser oscillator for each of red, green and blue;
a beam splitter which separates each of a red, green and blue laser beam into a reference beam and an object beam;
phase shifting means for shifting a phase of the reference beam of the three colors red, green and blue;
means for digitally recording an interference fringe of the object beam and the reference beam;
means for displaying on a spatial modulator a lattice fringe corresponding to a modulated phase of the reference beam of the three colors red, green and blue separated by the beam splitter, phase-shifting the three colors simultaneously, setting an incidence angle of the reference beam of the three colors red, green and blue on the spatial modulator so that a primary diffracted beam is superimposed on a straight line, employing, as a reference beam, a white primary diffracted beam composed of superimposed reference beam of the three colors red, green and blue, using, for an objected to be photographed, a white beam composed of a superimposed object beam of the three colors separated by the beam splitter, recording two interference fringes generated by the object beam and two reference beams shifted one from the other in the phase of the reference beam of the three colors red, green and blue;
interference fringe data computing means for computing two items of interference fringe data shifted in the phase of the reference beam of the three colors red, green and blue; and
reproduction image computing means for obtaining a reproduction image based on the interference fringe data computed by the interference fringe data computing means.

2. A three-dimensional color image recording apparatus according to claim 1, wherein a reflective liquid crystal panel is used as the phase shifting means for shifting the phase of the reference beam.

3. A three-dimensional color image recording apparatus according to claim 1, wherein a digital mirror device panel is used as the phase shifting means for shifting the phase of the reference beam.

4. A three-dimensional color image recording apparatus according to claim 1, wherein a CCD imaging device is used as the means for recording the interference fringes.

5. A three-dimensional color image recording apparatus according to claim 1, wherein a CMOS imaging device is used as the means for recording the interference fringes.

6. A three-dimensional color image recording apparatus according to claim 1, wherein an imaging device equipped with a color filter designed so that an optical transmittance characteristic curve is not superimposed is used as the means for recording the interference fringes.

7. A three-dimensional color image recording apparatus according to claim 1, wherein the two interference fringes, generated by the object beam and each of the two reference beams of the three colors red, green and blue with a phase difference of 180 degrees, are recorded.

8. A three-dimensional color image recording apparatus according to claim 1, wherein a computation calculates a difference between the two items of interference data with the reference beam of the three colors red, green and blue phase-shifted 180 degrees.

9. A three-dimensional color image recording apparatus according to claim 1, wherein a phase shift method is that a lattice fringe of an interstice d=4α displayed on a reflective spatial light modulator of which a pixel pitch is α is moved parallel by one pixel pitch Δx=α, and a phase shift amount of a primary diffracted beam is φ=π with respect to a beam of three primary colors red, green and blue.

10. A three-dimensional color image recording apparatus according to claim 1, wherein the phase shift method is that the lattice fringe of an interstice d=4α displayed on the reflective spatial light modulation element of which the pixel pitch is α is moved parallel by one pixel pitch Δx=α, 2α, 3α, and the phase shift amount of the primary diffracted beam is φ=π/2, π, 3π/2.
